(19) United States
(12) Patent Application Publication
(10) Pub. No.: US 2009/0274298 A1
(43) Pub. Date: Nov. 5, 2009

(54) METHOD FOR PRODUCING A SECURITY FEATURE ON A FLAT SUBSTRATE

(75) Inventors: MARTIN SCHMITT-LEWEN, Heidelberg (DE); BERND VOSSELER, Dossenheim (DE); KARL-HEINZ WALTHER, Rottendorf (DE); SONER AKKAYA, Heidelberg (DE)

Correspondence Address: LERNER GREENBERG STEMER LLP, P O BOX 2480, HOLLYWOOD, FL, 33022-2480, US

(73) Assignee: Heidelberger Druckmaschinen AG, Heidelberg (DE)

(21) Appl. No.: 12/503,294

(22) Filed: Jul. 15, 2009

Related U.S. Application Data
(63) Continuation of application No. PCT/EP2009/002914, filed on Apr. 22, 2009.

(30) Foreign Application Priority Data
Apr. 23, 2008 (DE) 10 2008 020 450.1

(51) Int. Cl. G09C 5/00; B32B 37/00; B44F 1/00; B32B 3/10; G06K 9/64

(52) U.S. Cl. 380/54; 156/297; 156/67; 156/60; 428/195.1; 382/217; 235/454; 235/494

(57) ABSTRACT

A security feature is produced on a flat substrate, e.g. on paper or board. Particles—forming a cryptographic random pattern—are applied, preferably scattered on, to the substrate or incorporated into the substrate. Flexible pieces of wire or fiber, in particular thin pieces of copper wire, are applied to or incorporated into the substrate in a feature area corresponding to the security feature. The security feature can be provided with a protective layer, e.g. a laminate. A security feature produced in accordance with the invention can be detected simply and faultlessly and evaluated cryptographically. Furthermore, it cannot be imitated, or can be imitated only uneconomically, with known printing processes.

### CROSS-REFERENCE TO RELATED APPLICATION

This application is a continuation, under 35 U.S.C. § 120, of international application PCT/EP2009/002914, which designated the United States; the application also claims the priority, under 35 U.S.C. § 119, of German patent application DE 10 2008 020 450.1, filed Apr. 23, 2008; the prior applications are herewith incorporated by reference in their entirety.

### BACKGROUND OF THE INVENTION

1. Field of the Invention

The present invention relates to methods for the production of a security feature on a flat substrate, wherein particles forming a cryptographic random pattern are applied to or introduced into the substrate. The invention further relates to a printed product with a security feature. Furthermore, the present invention also relates to a method for checking the authenticity of a product and to a method for protecting products against counterfeiting.

When checking the authenticity of printed products, such as certificates or pharmaceutical packs, various methods for the production of so-called security features are applied. In order to be suitable for mass production, the security features must be capable of cost-effective production yet nevertheless provide high reliability in the detection of counterfeits.

Printed products, in particular original certificates and packaging of expensive or sensitive products such as cosmetic articles or pharmaceutical products, can be protected in many ways against counterfeiting. Often, in order to increase the security against counterfeiting, combinations of complicated printing processes and print media are used, for instance in banknote printing (iris printing, guilloches, security papers, security threads, color-shift inks, see-through register means and many more). For mass-produced articles such as disposable packs, such combined, complicated and as a result normally expensive methods are, however, less suitable.

In addition to the production of printed security features, systems for the encryption of electronic data, based on what is known as public key cryptography, have been developed. In this case, a pair of keys that belong together are used, one of which is publicly accessible (public key) but the other is kept secret (private key). In this case, the two keys cannot be derived from each other without additional information. A message which has been encrypted with a public key can be decrypted again only with the secret key belonging thereto, and vice versa. The most widespread method in this regard is what is known as the Rivest-Shamir-Adelman Method (RSA). This method is implemented, for example, in the widespread software “Pretty Good Privacy” (PGP).

German published patent application DE 196 14 174 A1 discloses incorporating multilayer microparticles, for example in varnish, in order to identify substances or articles. The microparticles cannot be detected with conventional, less complicated means.

German patent publication DE 10 2008 014 322—which was published after the priority date of the instant application—describes a method for checking the authenticity of a printed product. In that case, a random feature can be produced, for example, by means of imperfections during cold film transfer.

According to German published patent application DE 10 2005 013 962 A1, random fine structures of a printed paper or other printed substrate are evaluated microscopically and used as a so-called fingerprint for the relevant document. This fingerprint can be stored in a database at the manufacturer of the security feature and inspected by means of database access by the user of the security feature. By means of the comparison of the fingerprint found on the product with the fingerprint stored in the database, the authenticity of the document at hand can be confirmed. As an alternative to this, the fingerprint can be encrypted with a secret key and applied to the product by the manufacturer of the security feature, for example printed. The user of the security feature is able to verify the fingerprint by decrypting it with the public key. However, the disadvantage with the method described is that both the manufacturer and the user of the security feature must have a respective high resolution device in order to record the fiber structure of the product. This is less advantageous for use in the authenticity checking of mass products. Something similar will be found in U.S. Pat. No. 4,423,415. The evaluation of the fine structures is possible only with complicated technical means.

German published patent application DE 103 04 805 A1 describes the application of a random pattern to a product, the reading of the random pattern, the extraction of what is known as a “fingerprint” from the random pattern in the form of a dataset and the storage of the fingerprint. In addition, the fingerprint is preferably provided on the product in encrypted form. During the authentication of the product, the fingerprint is once more extracted from the random pattern and agreement with the stored fingerprint is checked. To this end, the random pattern has to be registered with complicated technical means with a high resolution range, for example with a microscope, and the key used during the encryption, which is secret, which is to say not public, must be used. Both are less advantageous for use in the authenticity checking of mass products.

Furthermore, for example from the production of banknotes, it is known to incorporate fluorescent fibers in the paper and to check the authenticity of a banknote with UV light. However, individualized checking, which is to say checking the authenticity of a unique document, is not possible in this way.

### SUMMARY OF THE INVENTION

It is accordingly an object of the invention to provide a method of producing a security feature on a flat substrate which overcomes the above-mentioned disadvantages of the heretofore-known devices and methods of this general type and which makes possible the simple and cost-effective production of a security feature that is easy to detect (with conventional means, such as camera cell phones) and can be evaluated simply and faultlessly by cryptographic means. It is a further or alternative object of the present invention to devise a method and printed product which are improved with respect to the prior art and which permit good distinguishability, optically and/or haptically, between a true security feature and a security feature that is only imitated. It is a further or alternative object of the present invention to devise a method, improved with respect to the prior art, for checking the authenticity of a product and a method for protecting products against counterfeiting, which make it possible to use a security feature which can be produced simply and cost-effectively, can be detected easily (with conventional means, such as camera cell phones) and can be evaluated cryptographically simply and faultlessly.

It is yet a further or alternative object of the present invention to devise a printed product having a security feature which is improved with respect to the prior art, which is to say is easy to detect and can be evaluated simply and faultlessly by cryptographic means. It is a further or alternative object of the present invention to devise a method and printed product which are improved with respect to the prior art and which permit good distinguishability, optically and/or haptically, between a true security feature and a security feature that is only imitated.

With the foregoing and other objects in view there is provided, in accordance with the invention, a method for producing a security feature on or in a flat substrate, the method which comprises:
providing the flat substrate with a feature area for the security feature;
applying flexible pieces of wire or fiber in a cryptographic random pattern to the substrate in a feature area corresponding to the security feature.

In the alternative, or in addition, the pieces of wire or fiber may be incorporated in a cryptographic random pattern into the substrate.

In other words, a method according to the invention for the production of a security feature on a flat substrate, particles—forming a cryptographic random pattern—being applied to the substrate, is distinguished by the fact that flexible pieces of wire or fiber are applied to the substrate in a feature area corresponding to the security feature.

Further, a method according to the invention for the production of a security feature in a flat substrate, particles—forming a cryptographic random pattern—being introduced into the substrate, is distinguished by the fact that flexible pieces of wire or fiber are introduced into the substrate in a feature area corresponding to the security feature.

Within the context of this application, the term “flexible” is to be understood in the sense of “deformable”, in particular “pliant”. In this case, both elastic and plastic and also reversible and irreversible deformability can be provided. For instance, the pieces of wire or fiber can be deformed in such a way that they can be provided with a curvature along their longitudinal axis (or a plurality of curvatures), which is maintained permanently.

The use of pieces of wire or fiber permits good distinguishability between original and imitation (counterfeit), since the pieces exhibit a characteristic reflection of light because of their 3-D structure, can thus be detected as pieces with the naked eye from various angles and, in addition, the 3-D structure can also be felt. Moreover, the pieces can be superimposed and thus produce a more complex and even more clearly perceptible 3-D structure.

A development of the method according to the invention which is advantageous and therefore preferred on account of the improved detection properties can be distinguished by the fact that pieces of plastic or metal wire, in particular pieces of copper wire, are applied to the substrate or introduced into the substrate.

A development of the method according to the invention which is advantageous and therefore preferred with regard to simple production can be distinguished by the fact that the pieces of wire or fiber are applied, in particular scattered on, to a feature area of the substrate previously treated with adhesive.

A development of the method according to the invention which is advantageous and therefore preferred because of its robustness can be distinguished by the fact that the pieces of wire or fiber are covered with a protective layer, in particular with a laminate.

A development of the method according to the invention which is advantageous and therefore preferred on account of simple production can be distinguished by the fact that the pieces of fiber are transferred to the substrate with a fluid, in particular with printing ink or varnish.

A development of the method according to the invention which is advantageous and therefore preferred with regard to improved protection against counterfeiting can be distinguished by the fact that the pieces of wire or fiber have at least one curvature.

A further development of the method according to the invention which is advantageous and therefore preferred with regard to improved protection against counterfeiting and improved detection can be distinguished by the fact that colored or fluorescent pieces of wire or fiber are applied to the substrate or introduced into the substrate.

A development of the method according to the invention which is advantageous and therefore preferred because of its robustness and improved protection against counterfeiting can be distinguished by the fact that the pieces of wire or fiber are applied to the substrate after being introduced into a nonwoven or a film.

A printed product according to the invention having a security feature is distinguished by the fact that the security feature has flexible pieces of wire or fiber—forming a random pattern—applied to a substrate.

Also to be seen as within the context of the invention is a machine processing printing material, for example a press, in particular a sheet-processing rotary press for lithographic offset printing, or a print finishing machine, which is equipped to implement one of the aforementioned methods according to the invention, for example by means of appropriate application devices.

A method according to the invention for checking the authenticity of a product has the following method steps: a signature assigned to the product is registered, the signature is transformed by means of decryption into an identifier, a comparative feature is generated from the identifier and, with the aid of a computer, the comparative feature is compared with an image of a random pattern assigned to the product.

The method according to the invention advantageously permits the checking of the authenticity of a product, it being made possible to use a security feature which can be produced simply and cost-effectively, can be detected easily (with conventional means, such as camera cell phones) and be evaluated cryptographically simply and faultlessly.

A development of the method of the invention which is advantageous and therefore preferred on account of its trouble-free use can be distinguished by the fact that the signature is registered by a camera of a cell phone, and that the comparative feature is displayed in the display of the cell phone.

A development of the method of the invention which is advantageous and therefore preferred on account of the ability to detect counterfeits, which is reliable for the user, can be distinguished by the fact that the comparative feature is displayed in the display of the cell phone, superimposed on the image of the random pattern.

A method according to the invention for protecting products against counterfeiting has the following method steps: a cryptographic random pattern of flexible pieces of wire or fiber is produced, and the random pattern is registered by a camera, an identifier is generated from the image of the random pattern, the identifier is transformed with a secret key into a signature, the random pattern and the signature are applied to the product to be protected, the signature is registered by camera, the signature is transformed by decryption with a public key into the identifier, a comparative feature is generated from the identifier, with the aid of a computer, the comparative feature is superimposed on and compared with an image of the random pattern.

The method according to the invention advantageously permits the protection of products against counterfeiting, it likewise being made possible to use a security feature which can be produced simply and cost-effectively, can be detected easily (with conventional means, such as camera cell phones) and be evaluated cryptographically simply and faultlessly.

The invention described and the advantageous developments of the invention that are described also constitute advantageous developments of the invention in combination with one another. Of particular advantage is the successively performed application of adhesive, the scattering of pieces of wire, for example of copper, and the application of varnish or film. Likewise of particular advantage is the production of a sticky label having a cryptographic random pattern of flexible pieces of wire or fiber, and having an adjacent signature, representing the random pattern and encrypted, in the form of a 2-D bar code (data matrix code).

Other features which are considered as characteristic for the invention are set forth in the appended claims.

Although the invention is illustrated and described herein as embodied in a method for the production of a security feature on a flat substrate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of a first embodiment of a substrate and a security feature produced in accordance with the invention;

FIG. 2 shows a schematic view of a second embodiment of a security feature produced in accordance with the invention; and

FIGS. 3A-3E illustrate a process sequence in a preferred embodiment of a method according to the invention for protecting products against counterfeiting.

### DETAILED DESCRIPTION OF THE INVENTION

The security feature according to the invention on a substrate is based substantially on a special random pattern which, after its production in accordance with the invention, is registered and evaluated, i.e., is transformed into a characteristic vector describing the random pattern and into a signature—possibly supplemented by further data and (asymmetrically) encrypted. The signature produced in this way is likewise applied to the substrate, preferably printed, and during the authenticity checking is used for the comparison with the random pattern. For example, a comparative random pattern can be calculated from the decrypted signature or a comparative signature can be calculated from the random pattern. In both cases, the user must therefore be provided with a key, preferably a public key. Such a cryptographic method is described, for example, in German patent application DE 10 2008 014 322 (not yet published) for a random pattern produced with cold film or firmly adhesively bonded particles. The copending application DE 10 2008 014 322 is herewith incorporated by reference with regard to the cryptographic and evaluation method disclosed therein.

The random pattern described in this application forms a cryptographic random pattern, which means a random pattern which cannot be imitated or can only uneconomically be imitated and which, as a result of its special nature, permits registration, encryption, decryption and comparison in a simple and faultless manner. It thus serves not only for general security against counterfeiting and/or manipulation but also for individual product protection, which is to say individual products can specifically be recognized as counterfeits. In brief: a potential counterfeiter would not just have to be able to imitate or produce a random pattern of the same type but an identical random pattern in order to be able to counterfeit products. A cryptographic random pattern is preferably a local random pattern, which is to say a random pattern positioned specifically at a defined, locally limited point on the substrate and not a random pattern which extends substantially over the entire substrate or large areas thereof.

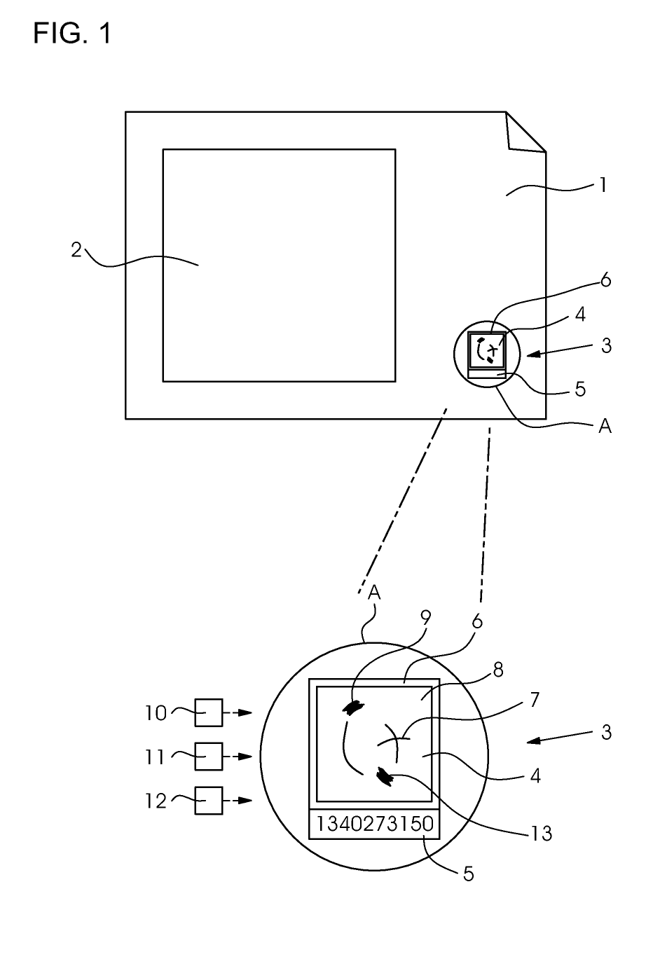

Referring now to the figures of the drawing in detail and first, particularly, to FIG. 1 thereof, there is shown a schematic view of a first embodiment of a security feature produced in accordance with the invention. A substantially flat substrate 1, preferably of paper, board or plastic (e.g. a paper or board sheet or a plastic label) preferably has a printed area 2, for example text and/or image. The substrate thus preferably forms a printed product, for example a product produced by lithographic offset printing, such as a pack. In addition, the substrate has a security feature 3 which is physically limited—preferably limited to an area of about 50 to about 500 square millimeters, for example about 20 by 20 millimeters in size. The security feature comprises a cryptographic random pattern 4 and a signature 5 corresponding thereto. As an option, the security feature can further comprise a preferably printed frame 6, for example in a dark or black color, or another marking, for example crosshairs. The frame is used substantially as a reference feature during the registration and evaluation of the random pattern. Detail A shows the security feature in an enlarged illustration.

The cryptographic random pattern 4 of the security feature 3 is produced, according to the first embodiment of the invention, in that flexible pieces of wire or fiber 7, which is to say wire or fiber material of limited length, are applied to the substrate in a feature area 8—corresponding to the security feature. Both the pieces of wire and the pieces of fiber are structures which are thin and therefore flexible in comparison with their respective length. Pieces of fiber differ from pieces of wire substantially in the smaller diameter. The pieces of fiber are also designated staple fibers. Preferably, about 3 to about 20 pieces are applied.

The flexible pieces of wire 7 used are preferably metal wire but plastic wire can also be used. Particularly preferred is copper wire, for example about 50 to 100 micrometers thick, in particular about 80 micrometers thick, and about 3 to about 30 millimeters long. The cross section is preferably circular. Copper is preferred because of its dimensional stability (substantially non-varying curvature), robustness with respect to subsequent processes, its inherent color, gloss and its easy detectability imparted thereby. At the same time, the optical (and haptic) appearance of pieces of metal wire can barely be imitated with conventional methods, for example with the application of cold film. Superimposed pieces of wire additionally have elevated and therefore easily detectable crossing points and do not tend to clump.

The flexible pieces of fiber 7 used are preferably artificial fibers (for example fibers of natural or synthetic polymers such as nylon; glass, carbon, metal or ceramic fibers), but use can also be made of natural fibers (e.g. plant fibers; fibers, hairs or silks of animal, including human, origin; mineral fibers). Also conceivable are threads, that is to say a fiber composite produced from the individual fibers (in this application, fibers is also understood to mean such fiber composites).

The production of the security feature 3 shown in FIG. 1 can preferably be carried out as follows: The feature area 8 is pre-treated with an adhesive 9 (for clarity, illustrated only partly and as lines), for example UV adhesive, that is to say brought into a tacky state by means of a local application of an adhesive 9 restricted to the feature area. For this purpose, an application device 10 can be used, for example a spray or roll device. The pieces of wire or fiber 7 are then scattered onto the feature area pre-treated in this way.

The scattering can be done, for example, with an air jet or with conveyor belts, generally with an application device 11. For this purpose, the pieces 7 from a supply are metered into an air jet and the latter, fanned out, is aimed at the feature area 8; or the pieces are moved from the supply onto a conveyor belt, of which the conveying speed can be varied, and conveyed onto the feature area. The scattering ensures a random three-dimensional distribution and orientation of the pieces within the feature area. In addition, the number of pieces in the feature area can be controlled via the pieces supplied per unit time and per unit area.

It is also possible to stock the pieces 7 in the form of a compacted object and, by means of a rotating brush or the like, to loosen them from the compacted object and feed them individually to the substrate 1.

Alternatively, the pieces 7 can also exclusively or additionally be fixed and protected against displacement or damage by means of a subsequent application of varnish or film (by means of an appropriate device 12), for example by means of a transparent or at least partly transparent laminate 13 (for clarity, illustrated only partly and as lines). If, instead, an opaque protective layer is provided, the elevations of the safeguard caused by the pieces—and preferably made more distinguishable by coloring—can be detected.

Alternatively, the wire or fiber material can be extruded or advanced and cut off to a predefined or random length. In this case, the pieces 7 can also have a predefined or random curvature impressed on them.

The pieces of wire or fiber 7 or the corresponding materials can additionally be colored, coated metallically, fluorescent or phosphorescent, for easier detection. The pieces preferably exhibit good optical contrast with respect to the substrate 1, for example dark or black pieces on a light or white substrate.

The cryptographic random pattern 4 produced in this way is detected by the producer in accordance with the method disclosed in the above-mentioned DE 10 2008 014 322, but in an appropriate way, instead of the cold film random pattern disclosed there in detail, and transformed into a signature 5, which is applied to the substrate 1. On the user side, the cryptographic random pattern or the signature can be detected and, by using a key that is made available, an authentication comparison can be carried out. In this case, a cell phone with camera, which registers the macroscopic properties of the random pattern, can be used.

From the recorded image, the position of the pieces of wire or fiber 7, orientation, curvature, crossing points, etc. can be extracted and the preferably only slightly curved pieces can be approximated by polygons, preferably with up to about 5 reference points. Given a nine-bit data set per coordinate of a reference point (corresponds to a 40 micrometer accuracy), assuming 10 pieces of wire or fiber, and 36-bit additional format information, the result is a considerably low total data set of only 117 bytes, with which the random pattern 4 can be described sufficiently accurately.

Alternatively, the pieces of wire or fiber can be applied to the substrate 1 after being introduced into a nonwoven. To this end, firstly a colored nonwoven with the pieces of wire or fiber 7 contained therein and preferably of a different color is produced, for example by means of thermal fusing, and a piece of this nonwoven feature area 8 is arranged on the substrate 1, for example adhesively bonded. Example: some thousands, preferably about 5000, dark or black fibers (about 20 to 200 millimeters long, about 10 to 100 millimeters thick, radius of curvature greater than about 5 millimeters) in a nonwoven of light or white fibers.

Further alternatively, the pieces of wire or fiber 7 can be introduced into a preferably transparent carrier material, for example a film, or admixed with the latter and applied to the substrate 1. For example, the plastic granules of the film that are made available can have the pieces of wire or fiber added to them and the film can be drawn, extruded or cast from this material. In this case, it is advantageous that the scattering and fixing of the pieces can be dispensed with and instead only the film produced in accordance with the invention is applied to the substrate in the feature area 8.

A further alternative can provide for the pieces of wire or fiber 7 to be introduced directly into the raw material for producing a pack, for example a plastic bottle, so that the random pattern 4 can be found again in the material of the pack—preferably only locally.

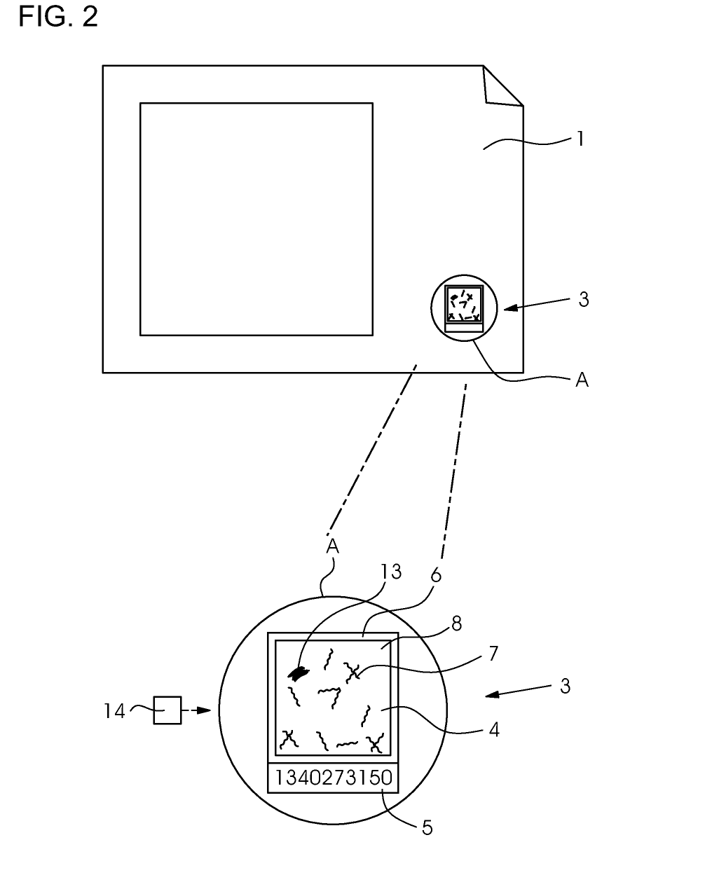

FIG. 2 shows a schematic view of a second embodiment of a security feature produced in accordance with the invention. Detail A shows the security feature 3 in an enlarged illustration. According to this embodiment, pieces of fiber 7 are transferred to the substrate 1 with or in a fluid 13 (for clarity, illustrated only partly and as lines), in particular with printing ink or varnish. In other words: a preferably light printing ink or a transparent varnish is admixed with the pieces of fiber before the printing. Using the fluid prepared in this way, the cryptographic random pattern 4 is produced by printing in a separate printing operation (by means of an appropriate device 1). The pieces of fiber used in this case preferably have a detectable and good contrast with respect to the fluid and the inherent color forming the substrate. Furthermore, the pieces of fiber can advantageously have a fluorescent property, so that under UV light improved detection is made possible.

The pieces of fiber 7 used can be present as substantially flat or crumpled pieces. In addition, branched individual pieces of fiber (typically natural fibers) or fiber composites of substantially unbranched or branched individual pieces of fiber can be used.

The printing operation can preferably be carried out by using a flexographic printing form 14 in conjunction with a simplified inking unit—not impaired by the pieces of fiber, for example halftone-free. As a result of printing the pieces of fiber 7, random positioning and orientation of the pieces is guaranteed.

Also in the embodiment according to FIG. 2, the recording and cryptographic evaluation of the random pattern 4 with conventional technology in principle available to any consumer, for example with camera cell phones, is made possible. Common to both embodiments, amongst other things, is the fact that the random pattern produced in each case can also be perceived with the naked eye, so that a first check on authenticity and plausibility is also possible without any technical aid. Furthermore, it is common to both embodiments that the random patterns produced in each case can be produced simply and cost-effectively, and the respective production process can easily be integrated into existing printing processes or presses.

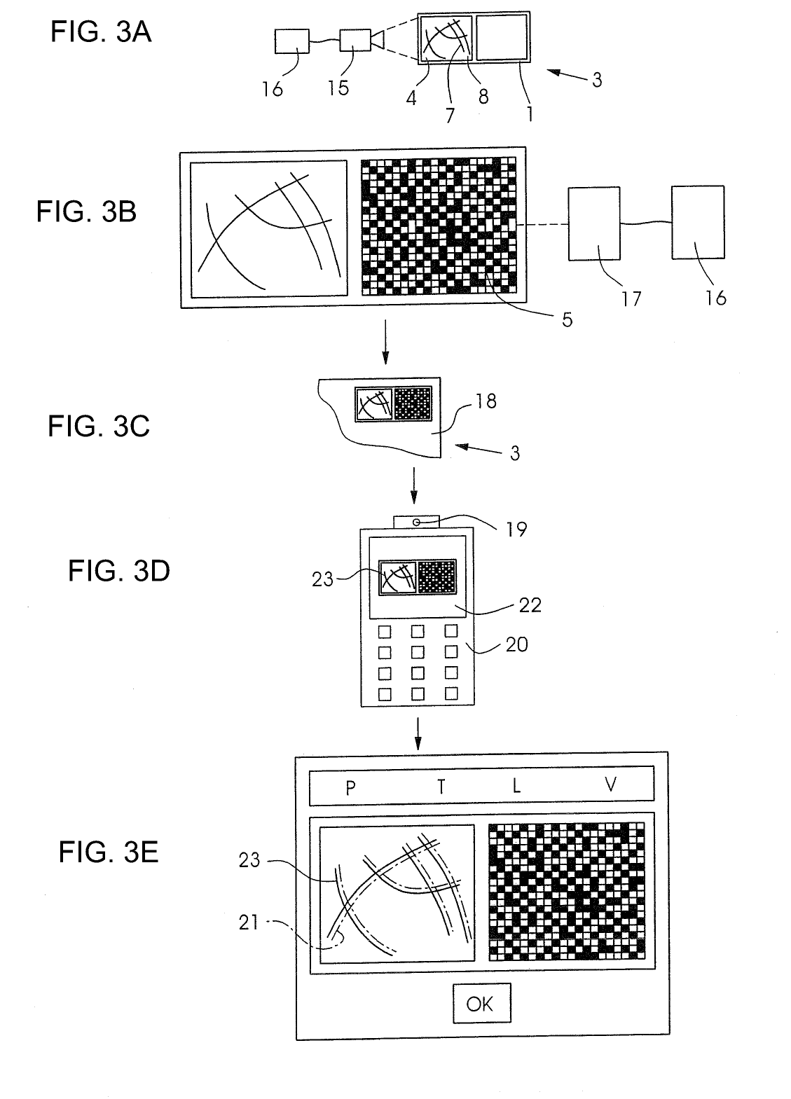

FIGS. 3A to 3E show a preferred exemplary embodiment of the method according to the invention for protecting products against counterfeiting or manipulation. Firstly, according to FIG. 3A, a two-dimensional cryptographic random pattern 4 of flexible pieces of wire or fiber 7, preferably about 1 cm² in size, previously produced and for example provided from a supply roll, is registered by a camera 15 by the manufacturer, which means still during the production of the security feature 3, and an image generated in the process or the associated image data from the random pattern 4 is supplied to a computer 16.

The computer 16 uses the image data to calculate a preferably binary identifying vector or an identifier, which contains the data about the pieces of wire or fiber, approximated by polygons preferably having up to about 5 reference points. The identifying vector can be supplemented by further data (what is known as additional information, such as manufacturer, product, use-by date, regional code, etc.). There then follows the encryption of the identifying vector by using a secret key, which means a key that is not public or not provided to the public. The encrypted identifying vector is then present as a signature. Consequently, the signature is derived from the identifier and the identifier from the random pattern. Later, which means during the authenticity checking, the signature can be transformed (back) into the identifier by using a corresponding non-secret key, which means a public key or one provided to the public. For the purpose of encryption and decryption, recourse can be had to conventional methods, preferably in accordance with the principle of what is known as public key cryptography, in turn preferably in accordance with what is known as RSA encryption (Rivest-Shamir-Adelman), which, for example, is also used in the widely used software “Pretty Good Privacy” (PGP).

When using RSA encryption, which nowadays counts as the most secure asymmetric cryptography system, the signature is at least as long as the key which is used for the encryption. Key sizes which are usual nowadays and count as secure in this case lie between about 640 and about 2048 bits. Because of the signature length, it is advantageous in this case to apply the signature to the printed product in a machine-readable form, for example in the form of a one-dimensional or preferably two-dimensional code (2-D bar code, data matrix code).

The signature 5 generated in this way is supplied by the manufacturer, according to FIG. 3B, from the computer 16 to a printer 17, preferably an inkjet printer, and applied to the substrate 1 by the latter, preferably adjacent to the feature area 8, in particular printed. The signature 5 is preferably applied in the form of a two-dimensional code (2-D bar code or data matrix code). The security feature 3 can additionally be provided with a protective layer, for example a laminate, in order to protect the pieces of wire or fiber 7 or their positions and the signature against damage.

The security feature 3 is then applied, according to FIG. 3C, to a product 18 to be protected, in the main a pack (examples: pharmaceutical pack, electronics pack, etc.) or a label (examples: for clothing, shoes etc.), preferably stuck on, and the product 18 is placed on the market, where it can be checked for authenticity on the part of the user, which means by the seller or the purchaser.

The authenticity checking is carried out in that, according to FIG. 3D, the security feature 3 is once more registered on the part of the user by a camera 19. This is preferably a sufficiently resolving camera 19 of a commercially available cell phone 20 with display. Commercial users, which means the sellers, or persons who are intended to discover counterfeits by means of tests carried out in the manner of random samples, can instead also be provided with professional testing devices having a higher resolution and a larger display.

A computer/memory located in the cell phone 20 provides the public key for decrypting the signature. This public key can be loaded onto the cell phone, (preferably already in advance) via a temporary, preferably encrypted (radio) data link from a public server, preferably belonging onto the security feature manufacturer. According to the invention and advantageously, it is not necessary for the secret key but only the public key to be transferred. By means of this public key, the signature 5 can be decrypted “on site”, that is to say by using the cell phone or the testing device at the point of storage or of sale/purchase. A further advantage of the invention is to be seen in the fact that the cell phone or testing device does not have to set up any link with the server of the original manufacturer at the instant of the checking, since the public key can already be downloaded from this server in advance. The method can therefore even be used at locations at which no links are possible, permanently or temporarily. Finally, the method according to the invention offers the advantage that only the public key and therefore a very small amount of data has to be provided locally (on the cell phone or testing device). In particular, it is not necessary to provide locally a comprehensive collection of data which contains all the images of random patterns for testing purposes previously recorded by the manufacturer.

By means of the decryption, the signature 5 is transformed back or calculated back into the identifying vector and the latter into the image of the cryptographic random pattern 4, the calculated image being used subsequently as the comparative feature 21. The authenticity checking ends with the computer-aided checking of the agreement between the comparative feature 21 and the cryptographic random pattern 4. To this end, the comparative feature 21 is preferably displayed on the display 22 of the cell phone 20 and in the process superimposed on the recorded image 23 of the cryptographic random pattern 4. In FIG. 3E, the comparative feature 21 and the image 23 are illustrated slightly offset for reasons of improved detectability. If the comparative feature 21 and image 23 agree, the comparative feature 21 can, for example, be displayed in green, otherwise in red, for example, in order to signal visually to the user the authenticity or the counterfeit in an easily detectable manner. In addition, “OK” or a comparable unique visual or acoustic signal can be output in the presence of authenticity. Depending on the result of the authenticity checking, the user, for example the potential purchaser of the marked product, makes his purchase decision.

By using the method described, it is possible without difficulty to distinguish a counterfeit product from an authentic product, example and original certificate or a pharmaceutical pack. Although a counterfeiter could generate a random pattern 4 with pieces of wire or fiber 7 and print on an (arbitrary) signature 5. Since he has no access to the secret key from the original manufacturer, however, the signature 5 is not properly derived from the random pattern 4. A check, which means the generation of a comparative feature 21 and a comparison with the random pattern 4 or the image 23 of the latter, thus discovers the counterfeit without any doubt and without any substantial time delay. In addition, the converse route, of transferring a signature 5 of an original to counterfeits, does not lead to success, since the potential counterfeiter is not specifically able to generate the associated random pattern 4.

Even for the case in which the potential counterfeiter comes into possession of one or more security features and applies these to defective or manipulated products, the deception can be discovered when references to this emerge from the decrypted additional information. For example, the additional information can contain a product code (which means a product-related restriction on the admissibility of sale), an expiry date/use-by date (that is to say a time restriction on the admissibility of sale), a regional code/sales code (that is to say an area restriction on the admissibility of sale), or a seller code (that is to say a person-related restriction on the admissibility of sale), which can make it extremely difficult for the potential counterfeiter to obtain money for his counterfeits. Example: the additional information decrypted and displayed to the user indicates that the product P may be offered by the seller V only until the day T in the country L. If the user finds any discrepancy between the displayed data P, T, L, V (see FIG. 3E) and the data given to him directly by the sales situation (which product is offered to him when, where and by whom?), then he can refrain from the purchase.

1. A method for producing a security feature on a flat substrate, the method which comprises:
providing the flat substrate with a feature area for the security feature;
applying flexible pieces of wire or fiber in a cryptographic random pattern to the substrate in a feature area corresponding to the security feature.

2. The method according to claim 1, which comprises applying pieces of plastic or metal wire to the substrate.

3. The method according to claim 2, which comprises applying pieces of copper wire to the substrate.

4. The method according to claim 1, which comprises treating the feature area of the substrate with adhesive and subsequently applying the pieces of wire or fiber to the feature area.

5. The method according to claim 4, which comprises scattering the pieces of wire or fiber on the feature area of the substrate previsouly treated with adhesive.

6. The method according to claim 1, which comprises covering the pieces of wire or fiber with a protective layer.

7. The method according to claim 6, which comprises covering the pieces of wire or fiber with a laminate.

8. The method according to claim 1, which comprises transferring the pieces of fiber to the substrate with a fluid.

9. The method according to claim 8, which comprises transferring the pieces of fiber to the substrate with printing ink or varnish.

10. The method according to claim 1, wherein the pieces of wire or fiber have at least one curvature.

11. The method according to claim 1, which comprises applying colored or fluorescent pieces of wire or fiber to the substrate.

12. The method according to claim 1, which comprises applying the pieces of wire or fiber to the substrate after being introduced into a nonwoven or a film.

13. A method for producing a security feature in a flat substrate, the method which comprises:
providing the flat substrate with a feature area for the security feature;
incorporating flexible pieces of wire or fiber in a cryptographic random pattern into the substrate in a feature area corresponding to the security feature.

14. The method according to claim 13, which comprises incorporating pieces of plastic or metal wire into the substrate.

15. The method according to claim 14, which comprises incorporating pieces of copper wire into the substrate.

16. The method according to claim 13, wherein the pieces of wire or fiber have at least one curvature.

17. The method according to claim 13, which comprises incorporating colored or fluorescent pieces of wire or fiber into the substrate.

18. A printed product, comprising:
a substrate having a security feature;
said security feature containing flexible pieces of wire or fiber forming a random pattern.

19. A method for checking the authenticity of a product, comprising the following steps:
registering a signature assigned to the product;
transforming the signature by way of decryption into an identifier;
generating a comparative feature from the identifier; and
with the aid of a computer, comparing the comparative feature with an image of a random pattern assigned to the product.

20. The method according to claim 19, wherein the registering step comprises registering the signature with a camera of a cell phone, and which further comprises displaying the comparative feature on a display of the cell phone.

21. The method according to claim 20, wherein the displaying step comprises displaying the comparative feature on the display of the cell phone, superimposed on the image of the random pattern.

22. A method for protecting a product against counterfeiting, comprising the following steps:
producing a cryptographic random pattern of flexible pieces of wire or fiber;
registering the random pattern with a camera;
generating an identifier from the image of the random pattern;
transforming the identifier with a secret key into a signature;
applying the random pattern and the signature to the product to be protected;
registering the signature with a camera;
transforming the signature by decryption with a public key into the identifier;
generating a comparative feature from the identifier; and
with the aid of a computer, superimposing the comparative feature on and comparing the comparative feature with an image of the random pattern.
